(19) United States
(12) Patent Application Publication
(10) Pub. No.: US 2012/0181966 A1
(43) Pub. Date: Jul. 19, 2012

(54) MOTOR SPEED CONTROL CIRCUIT

(75) Inventors: Hideaki Nakamura, Gunma-ken (JP); Toshiyuki Imai, Gunma-ken (JP)

(73) Assignee: ON Semiconductor Trading, Ltd., Hamilton (BM)

(21) Appl. No.: 13/349,313

(22) Filed: Jan. 12, 2012

(30) Foreign Application Priority Data
Jan. 12, 2011 (JP) 2011-003944

(51) Int. Cl. H02P 7/00

(52) U.S. Cl. 318/465

(57) ABSTRACT

A motor speed control circuit includes: a first determining circuit configured to determine whether a rotation speed of a motor is higher than a set first rotation speed based on a speed signal corresponding to the rotation speed; a second determining circuit configured to determine whether the rotation speed is higher than a set second rotation speed, which is higher than the first rotation speed, based on the speed signal; and a drive signal output circuit configured to output to a drive circuit configured to drive the motor a drive signal for increasing the rotation speed when the rotation speed is lower than the first rotation speed and decreasing the rotation speed when the rotation speed is higher than the second rotation speed, based on determination results of the first and second determining circuits.

### CROSS-REFERENCE TO RELATED APPLICATION

This application claims the benefit of priority to Japanese Patent Application No. 2011-003944, filed Jan. 12, 2011, of which full contents are incorporated herein by reference.

### BACKGROUND OF THE INVENTION

1. Field of the Invention

The present invention relates to a motor speed control circuit.

2. Description of the Related Art

A common motor speed control circuit controls a motor using feedback so as to reduce an error between the motor rotation speed and a target rotation speed (see, e.g., Japanese Laid-Open Patent Publication No. 2006-158177).

A motor speed control circuit of Japanese Laid-Open Patent Publication No. 2006-158177 includes an integrating circuit to reduce an error between the motor rotation speed and a target rotation speed with a so-called feedback loop being stabilized. Since such an integrating circuit generally requires a capacitor having a large capacitance value, when the motor speed control circuit is integrated, for example, external parts for the motor speed control circuit increases in number.

### SUMMARY OF THE INVENTION

A motor speed control circuit according to an aspect of the present invention, includes: a first determining circuit configured to determine whether a rotation speed of a motor is higher than a set first rotation speed based on a speed signal corresponding to the rotation speed; a second determining circuit configured to determine whether the rotation speed is higher than a set second rotation speed, which is higher than the first rotation speed, based on the speed signal; and a drive signal output circuit configured to output to a drive circuit configured to drive the motor a drive signal for increasing the rotation speed when the rotation speed is lower than the first rotation speed and decreasing the rotation speed when the rotation speed is higher than the second rotation speed, based on determination results of the first and second determining circuits.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of a motor speed control IC 10 according to an embodiment of the present invention;

FIG. 2 is a diagram illustrating a configuration of a determining circuit 20;

FIG. 3 is a diagram illustrating major waveforms in a determining circuit 20 when a rotation speed of a fan motor 15 is lower than a rotation speed R1;

FIG. 4 is a diagram illustrating major waveforms in a determining circuit 20 in a case where a rotation speed of a fan motor 15 is within a predetermined range;

FIG. 5 is a diagram illustrating major waveforms in a determining circuit 20 in a case where a rotation speed of a fan motor 15 is higher than a rotation speed R2; and

FIG. 6 is a diagram illustrating an operation of a motor speed control IC 10.

### DETAILED DESCRIPTION OF THE INVENTION

At least the following details will become apparent from descriptions of this specification and of the accompanying drawings.

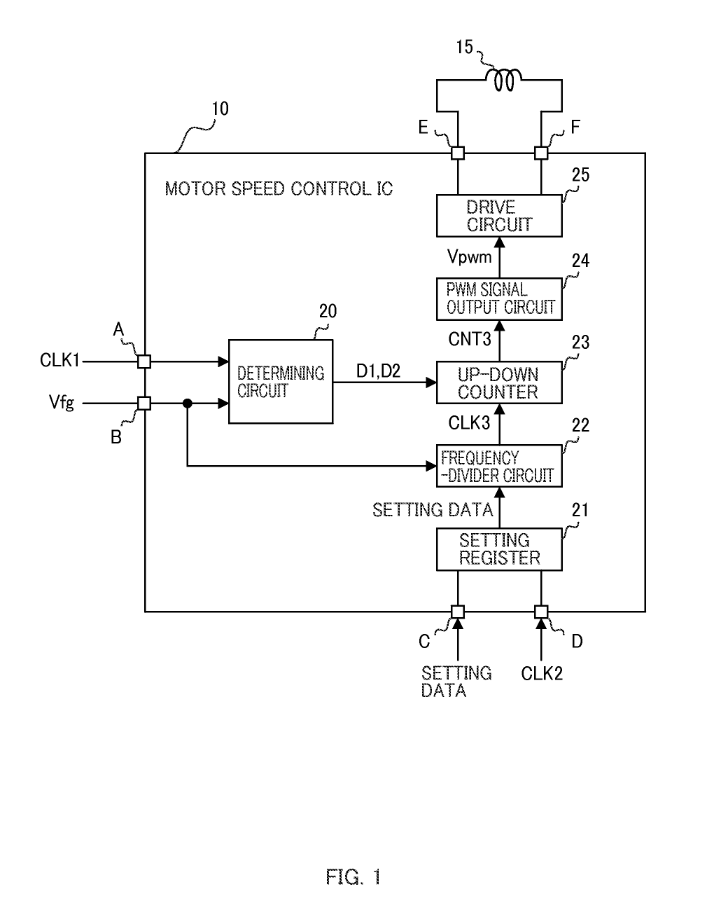

FIG. 1 is a diagram illustrating a configuration of a motor speed control IC (Integrated Circuit) 10 according to an embodiment of the present invention. The motor speed control IC 10 is a circuit configured to control the speed of a fan motor 15 to rotate a fan (not depicted). Specifically, the motor speed control IC 10 is configured to drive the fan motor 15 so that the rotation speed of the fan motor 15 is set within a predetermined speed range around a target rotation speed (e.g., within a range of the target rotation speed ±1%).

The motor speed control IC 10 includes a determining circuit 20, a setting register 21, a frequency-divider circuit 22, an up/down counter 23, a PWM (Pulse Wide Modulation) signal output circuit 24, a drive circuit 25, and terminals A to F.

A clock signal CLK 1 whose frequency is varied with a target rotation speed of the fan motor 15 is inputted to the terminal A.

A so-called FG (Frequency Generator) signal Vfg whose frequency is varied with an actual rotation speed of the fan motor 15 is inputted to the terminal B.

The determining circuit 20 is configured to determine whether the actual rotation speed is higher than a rotation speed R1 (first rotation speed) that is the lowest in the predetermined speed range, as well as determine whether the actual rotation speed is higher than a rotation speed R2 (second rotation speed) that is higher than the rotation speed R1 and the highest in the predetermined speed range. The determining circuit 20 outputs 2-bit data D1 and D2 indicative of a determination result.

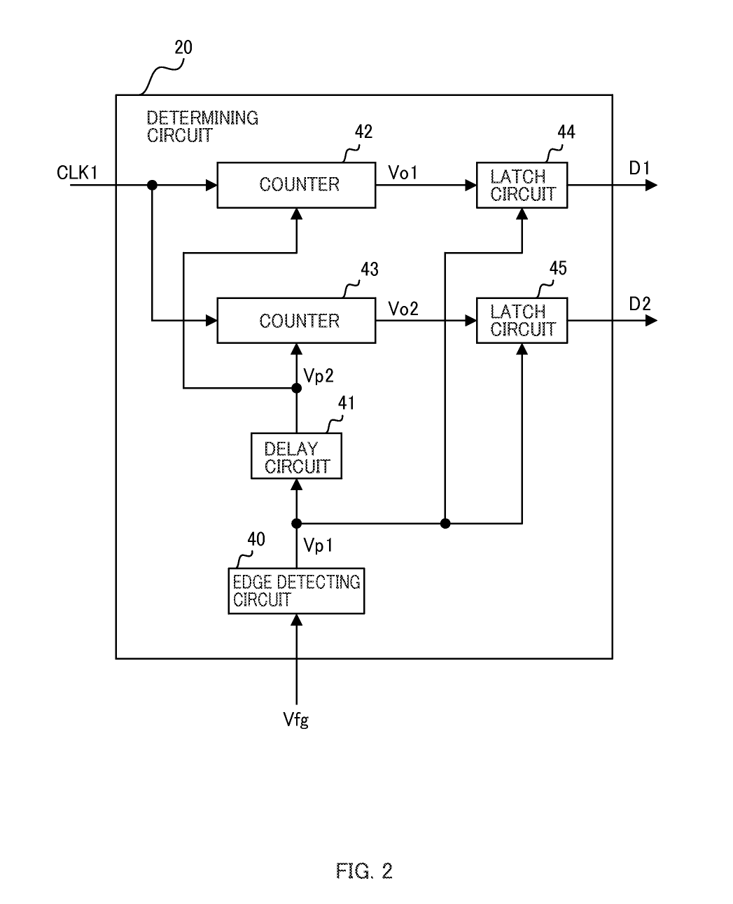

As depicted in FIG. 2, the determining circuit 20 includes an edge detecting circuit 40, a delay circuit 41, counters 42 and 43, and latch circuits 44 and 45.

The edge detecting circuit 40 is configured to output a high-level (H-level) pulse signal Vp1 every time the edge detecting circuit 40 detects a rising edge of the FG signal Vfg. In other words, the edge detecting circuit 40 is configured to output the high-level pulse signal Vp1 for each period of the FG signal Vfg.

The delay circuit 41 is configured to output a pulse signal Vp2 obtained by delaying the pulse signal Vp1 by a predetermined time (delay time).

The counter 42 (first determining circuit) is configured to increase a count value CNT1 by 1 every time the low-level (L-level) clock signal CLK1 goes high, and reset the count value CNT1 to zero, when the high-level pulse signal Vp2 is in putted thereto. The counter 42 causes an output signal Vo1 to go high when the count value CNT1 reaches a predetermined count value A1. In an embodiment of the present invention, the count value A1 is determined such that a time period T1 for the count value CNT1 to reach the predetermined count value A1 from zero is equal to a period of the FG signal Vfg when the fan motor 15 rotates at the rotation speed R1. Thus, when the actual rotation speed of the fan motor 15 is lower than the rotation speed R1, the high-level output signal Vo1 is outputted. That is to say, the counter 42 is configured to determine whether the actual rotation speed of the fan motor 15 is higher than the rotation speed R1.

The counter 43 (second determining circuit) is configured, in the same manner as the counter 42, to increase a count value CNT2 by 1 every time the low-level clock signal CLK1 goes high, and reset the count value CNT2 to zero when the high-level pulse signal Vp2 is inputted thereto. The counter 43 causes an output signal Vo2 to go high, when the count value CNT2 reaches a predetermined count value A2. In an embodiment according to the present invention, the count value A2 is determined such that a time period T2 for the count value CNT2 to reach the predetermined count value A2 from zero is equal to the period of the FG signal Vfg when the fan motor 15 rotates at the rotation speed R2. Thus, when the actual rotation speed of the fan motor 15 is lower than the rotation speed R2, the high-level output signal Vo2 is outputted. That is to say, the counter 43 is configured to determine whether the actual rotation speed of the fan motor 15 is higher than the rotation speed R2. Further, since the rotation speed R2 is higher than the rotation speed R1 as such, the count value A2 is smaller than the count value A1.

The latch circuit 44 is configured to latch the output signal Vo1 every time the pulse signal Vp1 goes high, to be outputted as the data D1. The latch circuit 45 is configured to latch the output signal Vo2 every time the pulse signal Vp1 goes high, to be outputted as the data D2.

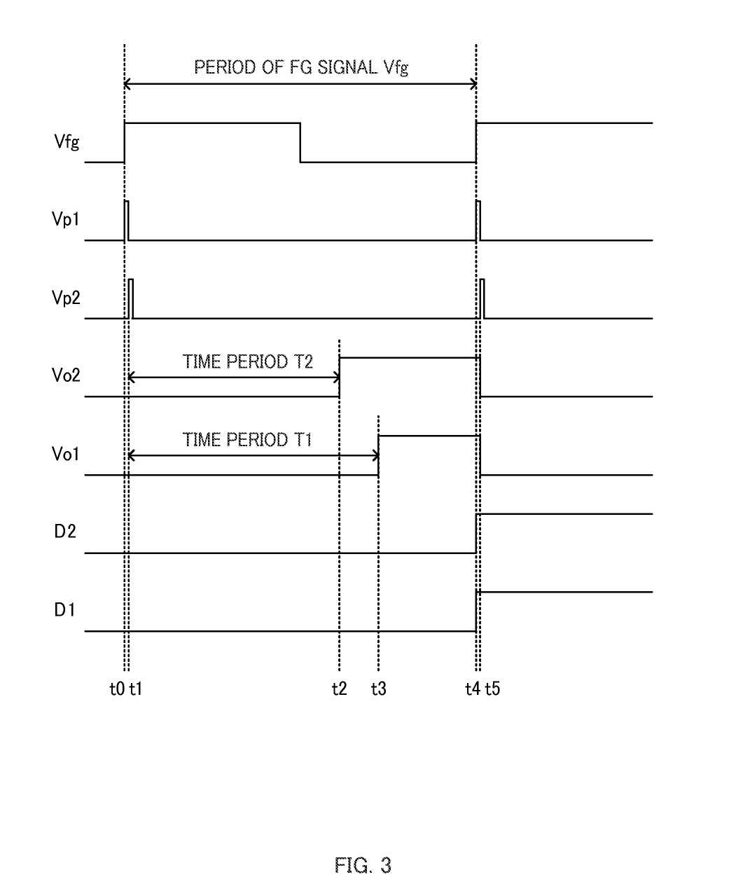

First, a description will be given, with reference to FIG. 3, of an operation of the determining circuit 20 when the actual rotation speed of the fan motor 15 is lower than the rotation speed R1 which is the lowest in the predetermined speed range, that is to say, when the period of FG signal Vfg is longer than the time period T1. Although the clock signal CLK1 is not depicted in FIG. 3, it is assumed that the period of the clock signal CLK1 is sufficiently shorter than the period of the FG signal Vfg at a time when the fan motor 15 rotates at the rotation speed R2.

When the FG signal Vfg goes high at a time t0, the high-level pulse signal Vp1 is outputted. At a time t1 when the delay time in the delay circuit 41 has been elapsed from the time t0, the high-level pulse signal Vp2 is outputted, thereby resetting the count values CNT1 and CNT2. At a time t2 when the time period T2 has been elapsed from the time t1, the count value CNT2 reaches the predetermined count value A2, so that the output signal Vo1 goes high. Further, at a time t3 when the time period T1 has been elapsed from the time t1, the count value CNT1 reaches the predetermined count value A1, so that the output signal Vo2 goes high. Then, at a time t4 when one period of the FG signal Vfg has been elapsed from the time t0, the high-level pulse signal Vp1 is outputted, so that both data D1 and D2 from the latch circuits 44 and 45 go high. That is to say, the determining circuit 20 outputs data (D1, D2)=(H, H). At a time t5, the count values CNT1 and CNT2 are reset. As a result, an operation starting from the time t2, as described above, is repeated in the same manner.

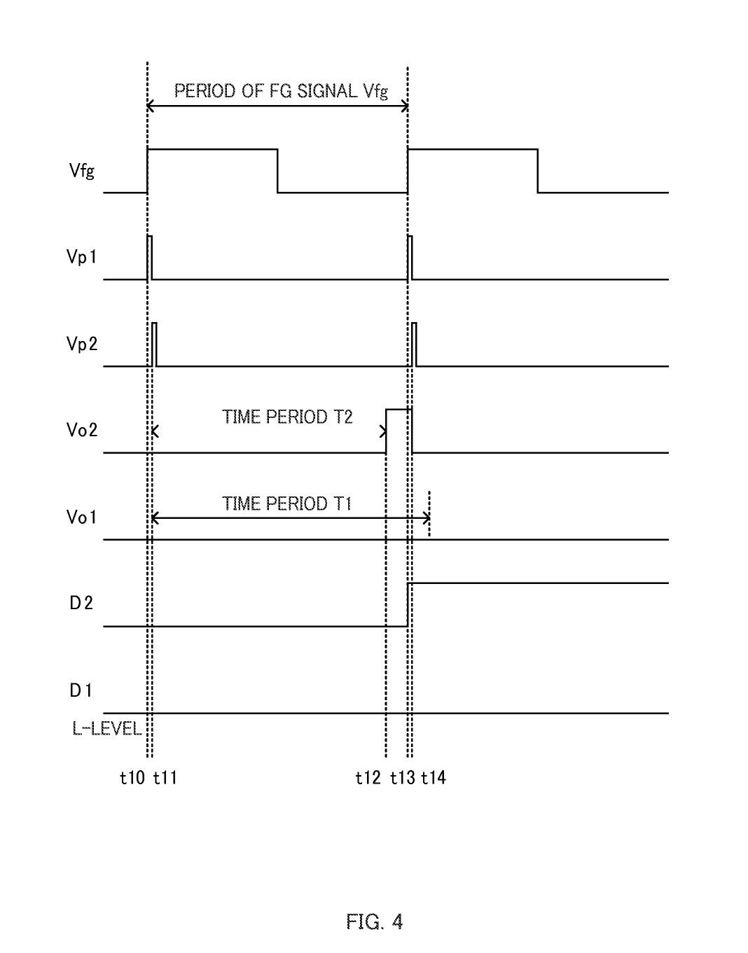

Next, a description will be given, with reference to FIG. 4, of an operation of the determining circuit 20 when the actual rotation speed of the fan motor 15 is within the predetermined speed range, that is to say, when the period of FG signal Vfg is longer than the time period T2 and is shorter than the time period T1.

When the FG signal Vfg goes high at a time t10, the high-level pulse signal Vp1 is outputted. At a time t11 when the delay time has been elapsed from the time t10, the high-level pulse signal Vp2 is outputted, thereby resetting the count values CNT1 and CNT2. At a time t12 when the time period T2 has been elapsed from the time t11, the count value CNT2 reaches the predetermined count value A2, so that the output signal Vo2 goes high. At a time t13 when one period of the FG signal Vfg has been elapsed from the time t10, the high-level pulse signal Vp1 is outputted, so that the data D1 remains low and the data D2 goes high. That is to say, the determining circuit 20 outputs data (D1, D2)=(L, H). At a time 14, the count values CNT1 and CNT2 are reset. As a result, an operation starting from the time 11, as described above, is repeated in the same manner.

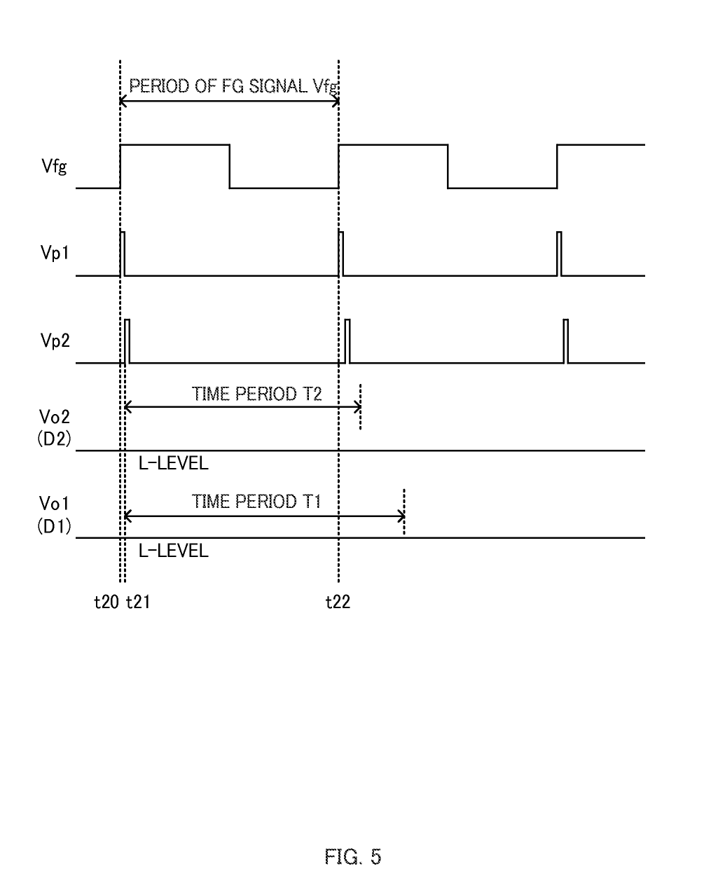

Further, a description will be given, with reference to FIG. 5, of an operation of the determining circuit 20 when the actual rotation speed of the fan motor 15 is higher than the rotation speed R2 which is the highest in the predetermined range, that is to say, when the period of FG signal Vfg is shorter than the time period T2.

When the FG signal Vfg goes high at a time t20, the high-level pulse signal Vp1 is outputted. At a time t21 when the delay time has been elapsed from the time t20, the high-level pulse signal Vp2 is outputted, thereby resetting the count values CNT1 and CNT2. At a time t22 when one period of the FG signal Vfg has been elapsed from the time t20, the high-level pulse signal Vp1 is outputted, so that the data D1 remains low and the data D2 also remains low. That is to say, the determining circuit 20 outputs data (D1, D2)=(L, L).

As such, the determining circuit 20 outputs the data (D1, D2)=(H, H) when the actual rotation speed is lower than the rotation speed R1, and outputs the data (D1, D2)=(L, L) when the actual rotation speed is higher than the rotation speed R2. The determining circuit 20 outputs the data (D1, D2)=(L, H) when the actual rotation speed is within the predetermined range.

The setting register 21 (memory circuit) stores setting data for setting a frequency-division ratio of the frequency-divider circuit 22. The setting data is inputted from a microcomputer, etc., in synchronization with the clock signal CLK 2. The setting data and clock signal CLK 2 are inputted via the terminals C and D, respectively.

The frequency-divider circuit 22 (clock signal generating circuit) is a programmable frequency-divider circuit configured to frequency-divides the FG signal Vfg at a frequency-division ratio based on the setting data and output a frequency-divided signal as a clock signal CLK 3.

When it is determined that the actual rotation speed is lower than the rotation speed R1, the up/down counter 23 increases the count value CNT3 1 by 1 in synchronization with every rising edge of the clock signal CLK 3. In other words, the up/down counter 23 operates as an up-counter when the data (D1, D2)=(H, H) is outputted from the determining circuit 20.

In contrast, when it is determined that the actual rotation speed is higher than the rotation speed R2, the up/down counter 23 decreases the count value CNT3 1 by 1 in synchronization with every rising edge of the clock signal CLK 3. In other words, the up/down counter 23 operates as a down-counter when the data (D1, D2)=(L, L) is outputted from the determining circuit 20.

When it is determined that the actual rotation speed is within the predetermined range and the data (D1, D2)=(L, H) is outputted from the determining circuit 20, the up/down counter 23 holds the count value CNT3. The count value CNT3 of the up/down counter 23 changes in a range from “0” to “100” (decimal system), for example.

The PWM signal output circuit 24 generates a PWM signal Vpwm whose duty ratio with respect to a high level (one logical level), for example, varies with the count value CNT3 of the up/down counter 23. When the count value of the up/down counter 23 increases by “1”, for example, the PWM signal output circuit 24 increases the duty ratio of the PWM signal Vpwm (drive signal) by 1%. The PWM signal output circuit 24 includes: a DA converter (not depicted) configured to convert the count value CNT3 in the form of digital data into an analog voltage; and a comparator (not depicted) configured to compare an output voltage from the DA converter with a triangular wave of a predetermined period, for example. The up/down counter 23 and the PWM signal output circuit 24 are equivalent to a drive signal output circuit.

The drive circuit 25 is configured to drive the fan motor 15 so that the rotation speed of the fan motor 15 connected between the terminals E and F increases with an increase in the duty ratio of the high-level period of the PWM signal Vpwm. The drive circuit 25 is provided as an H-bridge circuit, for example, and is supplied with power from a power supply circuit (not depicted).

### <<Operation of Motor Speed Control IC 10>>

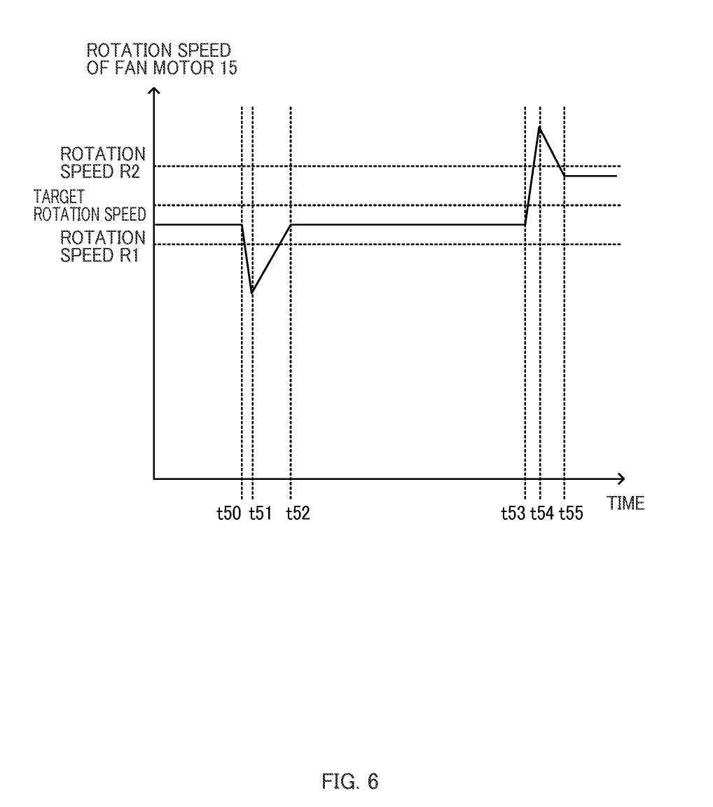

A description will be given, with reference to FIG. 6, of an example of an operation when the motor speed control IC 10 drives the fan motor 15. It is assumed that the setting register 21 stores setting data for setting a frequency-division ratio at “4”, for example. It is also assumed that the power supply circuit (not depicted), configured to supply power to the drive circuit 25, is configured to supply power to a circuit (not depicted) other than the drive circuit 25 as well.

At a time t50, if the power supply circuit becomes under heavy load, for example, to cause a power supply voltage applied to the drive circuit 25 to drop, the actual rotation speed of the fan motor 15 decreases to be lower than the rotation speed R1. At a time t51, if it is determined that the actual rotation speed is lower than the rotation speed R1, the up/down counter 23 starts operating as the up-counter. Thus, from the time t51 and thereafter, the count value CNT3 of the up/down counter 23 increases by 1 every 4 periods of the FG signal Vfg, thereby causing the rotation speed of the fan motor 15 to increase in a gradual manner. Then, at a time 52, if the determining circuit 20 determines that the actual rotation speed of the fan motor 15 is within the predetermined range, the count value CNT3 is stopped from changing.

At a time t53, for example, if the power supply circuit becomes under light load, for example, to cause a power supply voltage applied to the drive circuit 25 to rise, the actual rotation speed of the fan motor 15 increases to be higher than the rotation speed R2. At a time t54, if it is determined that the actual rotation speed is higher than the rotation speed R2, the up/down counter 23 starts operating as the down-counter. Thus, from the time t54 and thereafter, the count value CNT3 decreases by 1 every 4 periods of the FG signal Vfg, thereby causing the rotation speed of the fan motor 15 to decrease in a gradual manner. Then, at a time 55, if the determining circuit 20 determines that the actual rotation speed of the fan motor 15 is within the predetermined range, the count value CNT3 is stopped from changing. As such, the motor speed control IC 10 drives the fan motor 15 so that the rotation speed thereof remains within the predetermined range.

Hereinabove, the motor speed control IC 10 according to an embodiment of the present invention has been described. The motor speed control IC 10 is different from a common circuit configured to control a motor using feedback, in that the motor speed control IC 10 does not include an integrating circuit to stabilize a feedback loop. Thus, a capacitor with a large capacitance value is not required, which is required when the integrating circuit is employed, thereby reducing external parts in number.

If the actual rotation speed is lower than the rotation speed R1, the duty ratio of the PWM signal Vpwm is increased. If the actual rotation speed is higher than the rotation speed R2, the duty ratio of the PWM signal Vpwm is decreased. Therefore, the motor speed control IC 10 is able to reliably keep the rotation speed of the fan motor 15 within the predetermined range.

When the rotation speed of the fan motor 15 is within the predetermined range, the up/down counter 23 does not perform the operation of changing the count value CNT3. Thus, power consumption is reduced in the up/down counter 23.

It is possible that a clock signal of a predetermined period may be inputted to the up/down counter 23 in place of the clock signal CLK3. However, in a time period in which the rotation speed of the fan motor 15 is low, that is to say, in a time period in which the period of the FG signal Vfg is sufficiently longer than a predetermined period, the count value CNT3 may change significantly to cause the fan motor 15 to change in the rotation speed abruptly. In an embodiment of the present invention, the clock signal CLK3 is generated based on the FG signal Vfg, and thus the count value CNT3 that changes per period of the FG signal Vfg remains constant. Therefore, the motor speed control circuit IC 10 is able to prevent the fan motor 15 from changing in the rotation speed abruptly.

The frequency-divider circuit 22 frequency-divides the FG signal Vfg at a frequency-division ratio based on setting data stored in the setting register 21. Since the setting data can be set by a user by means of a microcomputer, etc., the user is able to freely set the count value CNT3 that changes per period of the FG signal Vfg. That is to say, the user is able to freely set a variation in the rotation speed of the fan motor 15.

For example, a frequency-multiplier circuit (clock signal generating circuit), which is configured to multiply the frequency of the FG signal Vfg at a multiplication ratio corresponding to setting data, may be provided in place of the frequency-divider circuit 22.

The count value CNT3 may be changed not based on the clock signal CLK3 but based on the data D1 and D2 from the determining circuit 20.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. A motor speed control circuit comprising:
a first determining circuit configured to determine whether a rotation speed of a motor is higher than a set first rotation speed based on a speed signal corresponding to the rotation speed;
a second determining circuit configured to determine whether the rotation speed is higher than a set second rotation speed, which is higher than the first rotation speed, based on the speed signal; and
a drive signal output circuit configured to output to a drive circuit configured to drive the motor a drive signal for increasing the rotation speed when the rotation speed is lower than the first rotation speed and decreasing the rotation speed when the rotation speed is higher than the second rotation speed, based on determination results of the first and second determining circuits.

2. The motor speed control circuit of claim 1, wherein
the drive signal output circuit includes:
an up/down counter configured to change a count value based on determination results of the first and second determining circuits; and
a PWM signal output circuit configured to output, as the drive signal, a PWM signal having one logical level whose duty ratio varies with a count value of the up/down counter, to the drive circuit, wherein
the drive circuit is configured to drive the motor so that the rotation speed increases with an increase in the duty ratio of the one logical level, and wherein
the up/down counter is configured to change the count value so that the duty ratio of the one logical level of the PWM signal increases when the rotation speed is lower than the first rotation speed and decreases when the rotation speed is higher than the second rotation speed.

3. The motor speed control circuit of claim 2, wherein
the up/down counter is configured to hold the count value when the rotation speed is higher than the first rotation speed as well as lower than the second rotation speed.

4. The motor speed control circuit of claim 3, further comprising
a clock signal generating circuit configured to generate a clock signal having a frequency corresponding to a frequency of the speed signal, based on the speed signal, wherein
the up/down counter is configured to change the count value in synchronization with the clock signal so that the duty ratio of the one logical level of the PWM signal increases when the rotation speed is lower than the first rotation speed and decreases when the rotation speed is higher than the second rotation speed.

5. The motor speed control circuit of claim 4, further comprising
a memory circuit configured to store setting data for setting a frequency-division ratio at which the speed signal is frequency-divided, wherein
the clock signal generating circuit includes a frequency-divider circuit configured to frequency-divide the speed signal at a frequency division ratio based on the setting data stored in the memory circuit and output a frequency-divided speed signal.
